(19) United States
(12) Patent Application Publication
(10) Pub. No.: US 2025/0165595 A1
(43) Pub. Date: May 22, 2025

(54) EXPERT PANEL MODELS FOR NEURAL NETWORK ANOMALY DETECTION AND THWARTING ADVERSARIAL ATTACKS

(71) Applicant: Alcon, Inc., Fribourg (CH)

(72) Inventors: Shruti Siva Kumar, Foothill Ranch, CA (US); Thomas E. Jackson, Laguna Niguel, CA (US); Sinchan Bhattacharya, Denton, TX (US); Ramesh Sarangapani, Coppell, TX (US); Uma Chandrashekhar, Trabuco Canyon, TX (US); Pranava Kumar Vemula, Brooklyn, NY (US)

(73) Assignee: Alcon, Inc, Fribourg (CH)

(21) Appl. No.: 18/951,860

(22) Filed: Nov. 19, 2024

Related U.S. Application Data
(60) Provisional application No. 63/601,705, filed on Nov. 21, 2023.

(51) Int. Cl. G06F 21/55; H04L 9/40

(52) U.S. Cl. CPC G06F 21/554; H04L 63/1425

(57) ABSTRACT

A system includes a machine learning (ML) engine in which a data store is coupled to a processing system. The processing system executes code to receive a dataset from the data store, and produces three models each comprising three tests. Each of the tests seeks to detect one of three anomaly types corresponding to each of the models. The processing system performs at least two of the three tests relating to each of the three anomaly types. Separately for each anomaly type, the processing system detects an anomaly when two-out-of-three (2oo3) tests conclude that the anomaly is present in the dataset. The dataset including the flagged anomalies is stored in a data repository. The anomaly is filtered from the dataset. The processing system is configured to use data from the dataset to retrain an existing trained ML model.

### CROSS-REFERENCE TO RELATED APPLICATIONS

The present application claims the benefit of priority to U.S. Provisional Application No. 63/601,705 filed Nov. 21, 2023, which is hereby incorporated by reference in its entirety for all purposes.

### INTRODUCTION

Products and systems that embody artificial intelligence (“AI”), when deployed in production, are susceptible to cybersecurity threats such as, for example, spoofing, tampering with the input data, trojan horses, and other malicious attacks. Inputs to the data repository that store data germane to the machine learning (“ML”) processes in such AI systems have become a target for adversarial attacks. The latter attacks typically involve a malicious actor that subtly modifies the data input into the AI system such that modified input data is undetectable to available defensive tools that rely on common statistical methods, outlier detection algorithms, and other standard input restrictions. Nonexhaustive examples of AI data repositories subject to these threats include those employed in medical device data systems, medical image storage and communication devices, vehicular systems, robotic systems, quantum computers, aerospace systems, and other platforms for which AI is deemed a viable and productive mechanism. In addition, quantum computers have been the victim of these attacks.

To better understand this emerging threat against AI, in 2021, one reputable source predicted that thirty percent (30%) of all cyberattacks will involve data poisoning or some other adversarial attack vector by 2022. This trend is exacerbated when considering the increasing number of cybersecurity systems that include AI and ML as part of their security threats These growing threats have forced academia and industry to take the threat against AI seriously. In spite of this awareness, realistic systems and techniques that are effective in rejecting such attacks remain unavailable or nonexistent, rendering AI systems increasingly exposed to the adverse consequences of malicious hacking practices.

### SUMMARY

Aspects of the disclosure address these and other deficiencies in the art. Most notably, the input to an AI machine, which is often hacked by malicious actors that may subtly pass outlying data without it being detected, thereby poisoning the ML data, has an adverse effect on the ML engine and AI results, compromising the overall integrity of the system. In the case of AI systems directed to healthcare and medical devices, these attacks often have an adverse effect directly on patient safety. The present disclosure proposes a multi-model approach at the input where each model includes a fixed number of tests, each test for locating a particular anomaly type. Within one of the models each test has a corresponding test in each of the other models. Each of the corresponding tests in the other models may have unique signatures for checking the same anomaly, which advantageously tends to dispose of biases that may be inherent in a single test. In addition, the models are effective in the area of “quantum safe” cryptography, and may be used to stop attacks that employ quantum computers as the calculation tool to circumvent protective measures, as described below.

In one aspect of the disclosure, a system includes a machine-learning (ML) engine incorporating a machine-learning (ML) engine. The ML engine includes a data storage unit (data store) networked to a hardware instrument. The hardware instrument includes at least one sensor used to collect data from a data source. The data stored in the data store is used for prospectively retraining a trained data model. The ML engine further includes a processing system configured to receive the data from the data store, confirm the presence of potential anomalies in the data using three models each comprising three distinct tests for detecting three respective anomaly types in the data, the confirming being operable to sequentially apply each test for detecting prospective anomalies that appear within a configuration of the data relevant to that test, wherein the filtering further includes detecting, for each anomaly type, the prospective anomalies using at least two of the three tests in the three models as a threshold for determining whether the data includes anomalous data corresponding to the anomaly type. As noted, each test may include conducting one or a plurality of different measurements or assessment types to increase the reliability of the determination as to whether anomalies of the type corresponding to the test are present. The processing system filters (or blocks) the anomalous data from the data when corresponding tests from at least two out of the three models identify the same anomalous data for the relevant anomaly type. The processing system may use the filtered data in retraining the trained data model.

In another aspect of the disclosure, a method of a processing system within a machine-learning (ML) engine receives, from a data store networked to a plurality of hardware instruments, data for prospective use in retraining a trained ML model. The processing system confirms potential anomalies in the data using three models. Each of the three models includes three tests for detecting three respective anomaly types in the data. The processing system sequentially applies each test for detecting prospective anomalies that appear within a configuration of the data relevant to that test. The processing system detects, for each anomaly type, the prospective anomalies using at least two of the three tests in the three models as a threshold for determining whether the data includes anomalous data corresponding to the anomaly type. The processing system filters (blocks) the anomalous data from the data when corresponding tests from at least two out of the three models identify the anomalous data for the relevant anomaly type. The processing system uses the filtered data in retraining the trained data model.

In still another aspect of the disclosure, a system includes a machine learning (ML) engine comprising a data store coupled to a processing system. The processing system is configured to execute code to receive a dataset from the data store, to produce three models, each of the models comprising three tests, each of the tests confirming to detect one of three prospective anomaly types corresponding to each of the models, and to perform at least two of the three tests relating to each of the three anomaly types. The processing system is further configured, separately for each anomaly type, to detect an anomaly when two-out-of-three (2oo3) tests conclude that the anomaly is present in the dataset, to filter the anomaly from the dataset; and to use data from the dataset to retrain an existing trained ML model.

In various embodiments, each of the three models include tests for point, collective, and contextual anomaly types for identifying the anomalous data. The three tests in the three models may include unique detection signatures configured to mitigate artificial intelligence (AI) bias when the anomaly types of the models are sequentially applied to the input data. In some embodiments, the data includes an image. The three tests in each of the three models may include an image aesthetic assessment for detecting the first anomaly type, an image impairment assessment for detecting the second anomaly type, and an artifact visibility assessment for detecting the third anomaly type. The image may include an optical coherence tomography (OCT) image.

In various embodiments, one or more of the three tests uses an ensemble of techniques or measurements for confirming whether potential anomalies are present for the respective anomaly type. The ML engine may further include a data repository for storing the filtered data prior to the filtered data being used for retraining the trained data model. The ML engine may be implemented in a secure cloud. The ML engine may be operable to use one or more of the following quantities for detecting anomalies: White-To-White (WTW); K-Readings; Anterior Chamber Depth (ACD); Axial Length (AL); Not-A-Number (NAN); overflow or underflow values; Pre-op sphere; cylinder or spherical equivalent; or IOL power. In other applications, the expert panel can use other, entirely distinct data sets as well.

In some embodiments, the processing system may further be configured to use an augmented model. The augmented model may be configured to combine two or more datasets within the data for detecting anomalies hidden in the combined datasets.

The above summary is not intended to represent every embodiment or every aspect of the present disclosure. Rather, the foregoing summary merely provides examples of some of the novel concepts and features set forth herein. The above features and advantages, and other features and attendant advantages of this disclosure, will be readily apparent from the following detailed description of illustrated examples and representative modes for carrying out the present disclosure when taken in connection with the accompanying drawings and the appended claims. Moreover, this disclosure expressly includes the various combinations and sub-combinations of the elements and features presented above and below.

### BRIEF DESCRIPTION OF THE DRAWINGS

The accompanying drawings, which are incorporated into and constitute a part of this specification, illustrate implementations of the disclosure and together with the description, explain the principles of the disclosure.

FIG. 1 is an exemplary diagram illustrating a cloud-based machine learning (ML) engine coupled via a network to hardware instruments in accordance with an embodiment.

FIG. 2A is an analogous illustration of an “expert panel” including three models for confirming whether prospective anomalies are in the data from the data storage unit (data store).

FIG. 2B is a diagram showing another configuration of the ML engine using a distributed processing system in accordance with an embodiment.

FIG. 2C is a diagram showing yet another configuration of the ML engine using a distributed processing system networked together in a cloud platform.

FIG. 3 is a conceptual diagram of a portion of (i) a singular neural network including a model for testing input data in an artificial intelligence (AI) environment and (ii) a malicious actor effecting an adversarial attack on the single neural network at the input by producing subtle fake input data points that are bypassed by the input security as unrecognized.

FIG. 4 is a conceptual diagram of a closed-loop artificial intelligence (AI) system including an ML engine implementing aspects of the disclosure.

FIG. 5 is an illustration of an expert panel including three models for evaluating input data for outliers or other anomalies, in accordance with an aspect of the disclosure.

FIG. 6 is an illustration of a three-model expert panel, each model testing for three attributes according to an embodiment.

FIG. 7 is a graphical example of outliers in each of three anomaly types, including tests for point anomaly types, collective anomaly types, and contextual anomaly types.

FIG. 8A-8B are exemplary flow diagrams describing illustrative test procedures for detecting three anomaly types in a three-model input system, according to an aspect of the disclosure.

FIG. 9 illustrates diagrams of data measurements that illustrates typical input parameters to an intraocular lens (IOL) power calculator, and that a test for a particular anomaly type may use in confirming potential anomalies.

FIG. 10A illustrates a graph relevant to an ML model that is trained to remove fake data in the dataset, in accordance with an aspect of the disclosure.

FIG. 10B illustrates a graph relevant to the ML model of FIG. 10A that illustrates the data after most of the fake or anomalous data were removed after training and applying the ML model to the data.

The appended drawings are not necessarily drawn to scale and may present a simplified representation of various features of the present disclosure, including, for example, specific dimensions, orientations, locations, and shapes. In some cases, well-recognized features in certain drawings may be omitted to avoid unduly obscuring the concepts of the disclosure. Details associated with such features will be determined in part by the particular intended application and use case environment.

### DETAILED DESCRIPTION

The present disclosure includes embodiments in many different forms. Representative examples of the disclosure are shown in the drawings and described herein in detail as non-limiting examples of the disclosed principles. To that end, elements and limitations described in the Abstract, Introduction, Summary, and Detailed Description sections, but not explicitly set forth in the claims, should not be incorporated into the claims, singly or collectively, by implication, inference, or otherwise.

For purposes of the present description, unless specifically disclaimed, use of the singular includes the plural and vice versa, the terms “and” and “or” shall be both conjunctive and disjunctive, and the words “including,” “containing,” “comprising,” “having,” and the like shall mean “including without limitation.” Moreover, words of approximation such as “about,” “almost,” “substantially,” “generally,” “approximately,” etc., may be used herein in the sense of “at, near, or nearly at,” or “within 0-5% of”, or “within acceptable manufacturing tolerances”, or logical combinations thereof. As used herein, a component that is “configured to” perform a specified function is capable of performing the specified function without alteration, rather than merely having potential to perform the specified function after further modification. In other words, the described hardware, when expressly configured to perform the specified function, is specifically selected, created, implemented, utilized, programmed, and/or designed for the purpose of performing the specified function.

The detailed description and the drawings or figures are supportive and descriptive of the present teachings, but the scope of the present teachings is defined solely by the claims. While some of the embodiments for carrying out the present teachings have been described in detail, various alternative designs and embodiments exist for practicing the present teachings defined in the appended claims. Moreover, this disclosure expressly includes combinations and sub-combinations of the elements and features presented above and below.

ML is a branch of a larger field of AI. ML uses statistically derived models to develop predictions. ML uses algorithms run on a processing system having one or more inputs into which empirical or historical data is introduced. The ML models may use algorithms to parse the data, develop an understanding of the data, and make informed decisions based on what was learned from the data. In short, ML evaluates the data and generates one or more outputs based on the evaluation.

The cornerstone of today's artificial intelligence (AI) advances, ML brings unique benefits to many areas of science, including medical imaging, optics, robotics, advanced and autonomous vehicle technology, and many others. One of the objectives of ML in the medical field, for example, is to execute maximal benefits to medical imaging and similar medical fields that may result in positive life changes. Another objective includes making autonomous driving possible. In the early years of computing, security architecture was more easily implemented in part because many or most of the models and data were locally available. Effective security measures could be taken against hacks due to the geographically localized nature of the machines used. Thus, it was easier to protect the models and data, at least because the security products were built to protect specialized areas.

By contrast, present computing resources are often spread across many locations, and cloud-based models, which expand these locations, are increasingly prevalent. Existing solutions are consequently largely ineffective to combat malicious attacks to data inputs due to the dynamic and real time requirements of these spread-out enterprises. A more practive and collaborative solution is needed for securing a modern set of ML-based models based on modern concepts like scalability and interoperability. Moreover, existing techniques involving ML security focus mostly on providing security at the beginning of the process, rather than on already-trained models. The circumscribed nature of existing security methods further limits its effectiveness.

In addition, there exist many problems involving adversarial attacks against neural networks (NNs), which are extensively used in AI. To combat these problems, practitioners developed AI systems in themselves to prevent certain types of attacks, such as trojan horse assaults. A significant problem with these conventional methods was that they were not focused on protecting the underlying AI system and the NNs associated with it. In particular, these proposed solutions were not focused on protecting the inputs to the underlying AI model itself.

Yet another application to which the expert panel achieves significant benefits is in the area of quantum computing. Quantum computers are increasingly used in the context of AI and ML, among other applications. In one aspect, the expert panel is configured to deploy “quantum safe” cryptography. The expert panel is not susceptible to quantum attacks due to the underlying cryptography since the models of the expert panel are based on a symmetric key with a larger key size, rather than asymmetric key cryptography (like RSA, ECC, ECDH), the latter being the type of cryptography that can be compromised using quantum computing. The expert panel is effectively being “future proofed” to address and protect against attacks leveraged on quantum computers.

For at least these reasons, solutions to protect AI systems from malicious attacks are limited in both scope and subject matter. For example, ML techniques have been applied to defensive security controls to help defeat security attacks with intrusion detection. Other cloud-based controls may be used to protect ML activities in the cloud. None of these techniques involve the use of multiple models or any kind of voting scheme. Yet another area of current research involves the use of ML itself to defend against attacks enabled by ML. This latter technique is limited by the very types of problems articulated above with respect to AI systems in general. Thus, in spite of these efforts, existing or proposed research does not extend into the actual protection of the already-trained models in general, and the data input(s) for these models in particular. The proposed solutions to date tend to focus on Trojan attacks, data poisoning and the training process. The inventors are not aware of any viable solutions to adversarial attacks involving up and running AI systems. More fundamentally, current solutions lack a focus on protecting the model data input to an AI system. This critical part of the AI framework is required to detect diverse types of anomalous input that in the context of medical imaging, for example, can lead to adverse patient outcomes. To date, no such viable solutions have been implemented.

In one aspect of the disclosure, an AI Expert Panel system, referred to also sometimes as the “AI Xpert Panel,” is a set of code-based models, each including multiple analogous tests, that minimizes the risk of anomalous, fake, deceptive or malicious data being introduced into the ML model by using a triple redundancy, two-out-of-three (also called “2oo3” for purposes of this disclosure) voting scheme. The 2oo3 voting scheme may be implemented locally as any form of software, middleware, or firmware, such as a script, a plugin, an application or suite of applications, an application programming interface, etc. The types of hardware and input ports to the AI system may change with different applications. In various embodiments, the 2oo3 voting scheme may be automatedly upgradeable to account for updates or changes. In the case of a medical device, or a plurality of identical medical devices, for example, the location of the input data ports into a server or computer system that stores patient images may reside in the office of a surgeon, a central office within a hospital, or at an offsite remote location accessible via a network.

The 2oo3 voting scheme may also be implemented in a cloud AI configuration, where the ML is performed in a cloud environment and where the 2oo3 voting scheme may be local to the medical devices, or in some embodiments, it may be deployed in a proprietary cloud platform. In an embodiment, the expert panel including the 2oo3 voting models may be implemented as one or more applications executing on a processing system including memory, such as dynamic random access memory (DRAM).

While the application here is implemented as a three-model (panel) scheme, it will be appreciated that in other embodiments, another number of models may be used, such as an odd number greater than three. Thus, in other embodiments, the expert panel may include 4005, 5007, 6009, and the like. The initial digit representing the number of tests identifying the anomalies (outliers) of a particular type may also change in various embodiments. In still other embodiments where suitable, the number of models that make up a majority may also vary. For example, some embodiments may employ a different number of models, such as five. Accordingly, the 2oo3 is but one example of several multi-model “majority rules” approaches that may be used to protect the input data into the AI model. That said, one benefit of the 2oo3 approach within the context of many ML frameworks is the balance between efficiency in the monitoring of the system (e.g., the expert panel can work fast and in real-time) and lesser expenses to produce the associated hardware or code.

This detection component (e.g., the expert panel) in one embodiment includes three distinct models that rely on the concept of multiparty consent. The expert panel is a filter of sorts, in which subtle modifications to the data that turn out to be unintended or malicious are rejected. Because the ML is performed using the input data, the 2oo3 filter automatedly allows the trained data to be trusted and leveraged for better patient outcomes in a medical device setting. Technologies that may benefit from the expert panel may include vector-based datasets, Optical Coherence Tomography (OCT) imaging, Positron Emission Tomography (PET) scans, Computed axial tomography (“CAT”) or Computed Tomography (“CT”) scans, Magnetic Resonance Imagining (MRI), B-scan ultrasonography, and the like, along with any number of AI-supported technologies in non-medical fields including robotics, consumer appliances, speech recognition, vehicles and other forms of transport, and AI tools like ChatGPT.

AI products, including but not limited to the above systems, are susceptible to adversarial attacks. Adversarial attacks are small and often imperceptible malicious algorithms designed to exploit an ML model by using input data intended to mislead AI classifiers, the latter of which sort data into distinct categories. In the context of medical devices, the data collection mechanism is exposed to malicious attacks at the point(s) of entry of the input data. Examples include input ports to a surgical device, personal computer, or infrastructure in a surgeon's office, inputs to a cloud-based AI solution, and the like. Such modified data cannot be generally detected as fake by common statistical methods and outlier detection algorithms in proposed or existing implementations. Thus, this data cannot be trusted and leveraged to support reliable outcomes.

By contrast, according to various aspects of the disclosure, a substantially reduced risk of anomalous, fake, deceptive, or malicious data being introduced into an ML trained model can be achieved by the AI multi-model expert panel. This innovation introduces in one embodiment a triple redundancy, 2oo3 voting scheme in the model architecture using three distinct models that implement multi-party consent using a plurality of tests for each model to detect different anomaly types as described further below. The 2oo3 scheme of the target apparatus, when implemented at each of the respective data inputs (if more than one), allows the models to disagree in real-time as to the character of the data on any input and ultimately by rejecting malicious input (e.g., in the medical field), the 2oo3 models allow the predictions from the ML component to make the best decisions for patient outcomes. Instead of relying on a single model as is the conventional “norm” for managing model predictions that can easily become a target of deceptive and malicious techniques, like trojan attacks, stealthy triggers or backdoors into a single model, this innovation in one aspect introduces a triple redundancy voting scheme that enables all three models to independently assess the incoming data upon which the ML processes will otherwise rely. This multi-model assessment results in building trust in the data to be used to improve patient outcomes in the medical field, which positively impacts patient safety.

In various embodiments, this innovation leverages a unique solution to the problem by creating a “panel of experts” to argue in real-time about the Machine Learning model data input. The disagreements allow for the filtering of anomaly detection and any malicious input at the model level since there is multi party consent. In the embodiment where three models are Employed, the design as noted uses a “2 out of 3” (2oo3) voting scheme in which outlier data points are far more easily detected and filtered from the input data because multiple models are used to assess the data and the different possible anomalies. For purposes of this disclosure, an “anomaly” broadly refers to any type of malicious or fake data, or data not proper for use in the ML loop, regardless of whether the fake of improper data was the result of an adversarial attack by a malicious actor, or the product of a trojan horse or other malicious program, improper data that was simply accidentally fed back to the input to the ML system, or data that is clearly inaccurate and does not belong in the dataset.

The example 2oo3 model structure can similarly be applied to safeguard a variety of different types of AI models-optical, medical, automotive, aerospace, search engine-based and many others.

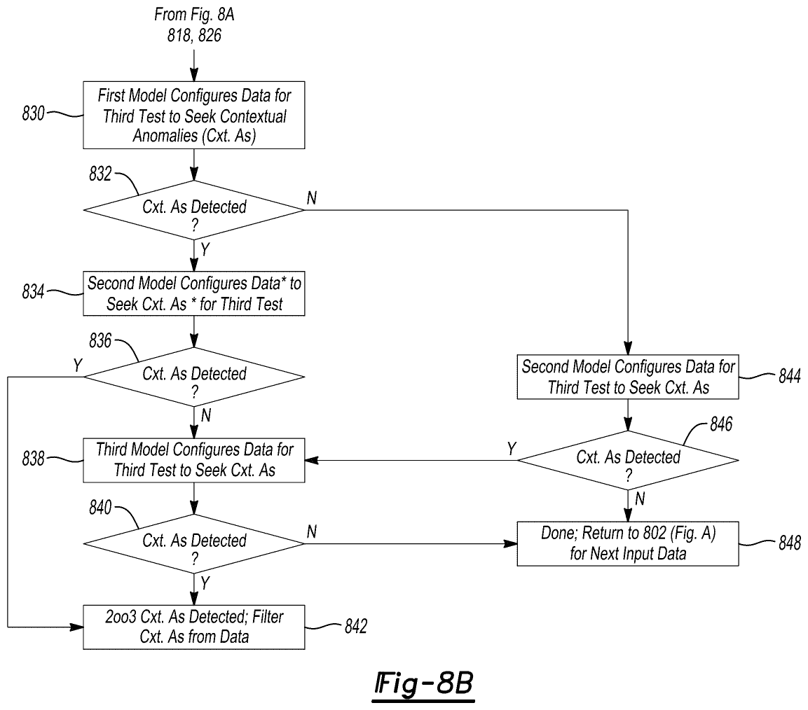

In further aspects of the disclosure, each model in the expert panel has attribute signatures for distinct anomaly detection and works alongside other experts in the panel. That is to say, each of the models in the panel includes a plurality of tests, each test for confirming potential anomalies of a particular type. For example, in a three-model architecture, each model may include three tests (for example) such that each test is configured to confirm that a potential type of anomaly for detection. For a first test in the first model, the second and third models will each have first tests confirming whether anomalies of the same anomaly type as the first test in the first model. In this case, the three tests may each have different signatures and may use different techniques to attempt to confirm presence of the prospective anomalies of the relevant anomaly type. In this example three-model architecture, each model may include a second test for confirming another respective potential anomaly type, and each model may include a third test for confirming yet another prospective r respective anomaly type. In one scenario, when two-out-of-three (2oo3) tests from 2oo3 models detect the same anomalies, the expert panel concludes that the detected anomalies are in fact outliers, and the detected anomalies are filtered from the input data. In this embodiment, the first model moves on to the second test to confirm presence of a possible second anomaly type. If no such anomaly is found, for example, the first model moves on to the third test to confirm a possible third anomaly type. If no third anomaly type is detected, the second model in this embodiment proceeds to employ the first test (if no anomaly corresponding to the first test was identified by the models) or the second test (if 2oo3 tests detected the presence of anomalies of a first type). An example of this embodiment is further described in more detail with reference to FIGS. 8A-8B. As noted, each test for the same anomaly type from the different models may have distinct signatures and use different measurements or sub-tests for seeking anomalies of the same type. Exemplary such measurements in the context of an example ocular medical field are described further below. The tests within the various models can agree in real time as to whether or not anomalies of a given type are present. If a test in only one model detects an anomaly, for example, and the applicable tests in the other two models do not detect the anomaly, then the expert panel concludes that the risk of introducing the data including the detected potential anomaly is acceptable, and the data is allowed including the potential anomaly. If none of the models detect a specific anomaly type using their respective analogous tests, for example, then the expert panel concludes that there is virtually no risk in sending the data. Otherwise, if the analogous tests of 2oo3 models (in other words, 2oo3 tests) detect the same anomaly, the expert panel concludes that the risk is too great to use the detected anomaly. Thus, the expert panel (which can be implemented as code on a processing system, or in hardware) filters the detected anomaly from the input data. As noted in greater detail below, the processing system implementing the expert panel including the filters for filtering the detected anomaly may include various hardware elements as well, such as field programmable gate arrays (FPGAs), application-specific integrated circuits (ASICs), combinational logic, and combinations of different techniques performing functions that implement the models described herein.

The principles of the disclosure enable practitioners to have a high degree of confidence in the integrity of the ML engine. In the example three-model panel, a risk assessment can be monitored to track the quality of the data, and the viability of the model. In the above example, where all three tests for a particular anomaly type conclude that there are no outliers, the chances are high that the data is free of inaccuracies based on that anomaly type. The same is true for the remaining anomaly types. A three-model assessment of no anomalies provides the practitioner with a high degree of confidence in the data. In cases where two of three tests of a particular anomaly type indicate that the data is anomaly-free, risk assessment procedures establish sufficiently high confidence in the data. The same is true of the other two tests. Where, however, anomalies are identified in 2oo3 of the tests for an anomaly type, risk assessment establishes that there is not sufficient confidence in the data points identified as anomalies. Hence those anomalies are removed.

In various embodiments, each model includes three tests for detecting anomaly, collective and contextual anomaly types. It should be understood that, even though this example involves three models each having three tests of a particular type (wherein each test may have different detection signatures), in other embodiments another number of tests may be used. For example, each of the three models may include four tests for detecting four anomaly types. In addition, while three models are used in these examples as an excellent compromise between accurate risk assessment and practical real-time use, a different number of models can be selected (e.g., five, seven, and the like) in different circumstances.

Continuing with the present example, this filtering logic allows anomaly detection using the three models, with each model including three steps. In an embodiment, filtering starts at step 1) point anomaly, then if (and only if) there are no point anomalies, step 2) collective anomaly detection is applied. Lastly, if there are point and collective anomalies detected, step 3) contextual anomaly detection is applied. This logic is then repeated for each of the models in the panel. This filtering and multiparty consent model allows the panel to detect anomalies, which include inaccurate, malicious, and fake data.

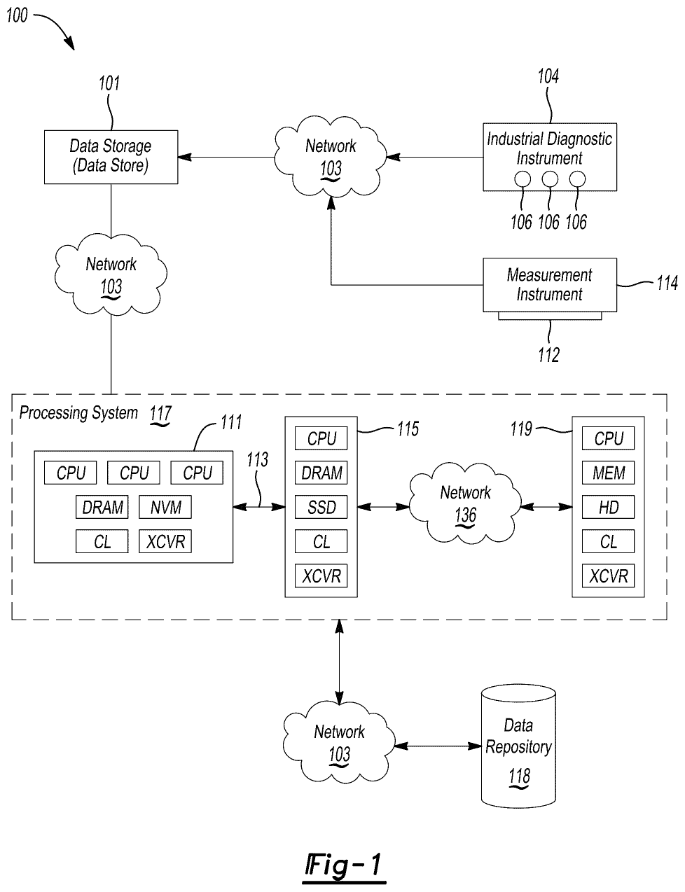

FIG. 1 is an exemplary diagram 100 illustrating a cloud-based machine learning (ML) engine coupled via a network to hardware instruments in accordance with an embodiment. The ML engine in this example includes the processing system 117, networks 103, and data storage unit or data store 101. The data store 101 may be a volatile memory (VM) or a non-volatile memory (NVM) of data that stores data collected from sensors of a hardware instrument, conclusions from professionals, etc. The processing system 117 is configured to obtain the data in blocks, packets, or streamed depending on the implementation. For example, the data from the data store 101 may be sent to a memory (e.g., DRAM, NVM, solid-state drive (SSD) or memory (MEM) in the processing system 117 for subsequent testing by the expert panel. The data in the data store 101 may originate from one or both of (1) data obtained from the trained ML model and transmitted over network 103 to the data store 101, and (2) data obtained from data sources (e.g., patients in a medical AI system or identifiable anatomical regions within the patient) using a hardware instruments and sensors that may have been previously calibrated or otherwise adjusted based on information from the earlier trained ML model. For example, with respect to FIG. 1, the data store 101 may include data obtained from sensor 106 and sensor 112 from hardware instruments respectively including an industrial diagnostic instrument 104 and a measurement instrument 114. There may be any number of hardware instruments, whether in one location (e.g., a hospital) or distributed across a wide geographical area of different locations including doctors' offices (or other companies or manufacturing locations for other AI applications).

In an embodiment, the hardware instruments are identical to each other, even though they are geographically remote from each other. In still other embodiments, the hardware instruments may include a wide variety of different instrument types, each of which benefit from the ML-engine. In the example of a medical setting, the hardware instruments 104 and 114 may be in a single location, or they may be distributed across a number of different geographical locations. In an embodiment, data store 101 is part of a customized and secure cloud platform. The data store 101 collects data from hardware instruments 104 and 114, which hardware instruments obtained the data from some data source via sensors 106 and 112. The data source may include any number of sources depending on the AI application, but in the example of the medical clinic for optometry or ophthalmology, the data source may include the biometric data of the patient's eyes. The hardware instruments may be operable to execute various functions when in the process of gathering data. In various embodiments, the hardware instruments 104 and 114 may be part of a deploy environment that may also include data representing the trained ML model obtained from the processing system 117.

In some embodiments, the data store 101 may include a combination of data from the hardware instruments 104 and 114 along with the data representing an existing trained ML model. The data store 101 may constitute any type of storage, whether isolated, housed in another hardware instrument with sensors (not shown), or part of a server or other computing device. In an embodiment, the sensors 106 and 112 from the hardware instruments 104 and 114 may be calibrated or otherwise modified by the trained ML model obtained from the processing system 117 in the context of a deploy environment (described further herein). One such example of a deploy environment is SmartCataract™ from Alcon. In other embodiments, the data store may represent data from various doctor's offices or surgical clinics in the context of the relevant medical setting. The data in turn may be transmitted to the processing system 117 over network 103 as an input to which initially, the principles of the expert panel use their constituent models to process the data for filtering anomalies. The filtered data (that is, the data that was not deemed to include anomalies, or data in which the models of the expert panel removed the anomalies) may then be processed by the processing system.

Initially, in this embodiment, the data that originated from one or more hardware instruments (e.g., industrial diagnostic instrument 104 via sensors 106 and measurement instrument 114 via sensor 112) may be sent to the data store 101 via network 103 to the processing system 117, and then sent via a network 103 to the data repository 118. The data repository 118 stores the measurement data for use in retraining the existing ML model, which may reside in one of the memories or storage devices included within the processing system 117. In some embodiments, the ML model may be stored along with the filtered data in the data repository. In other embodiments, the data repository 118 may include only the filtered data, and then may be subsequently stored in another memory included in the processing system. A number of variations of these embodiments are possible. As an example, the ML engine may be connected to hardware instruments in a simpler AI system, which may all reside in one location. In the various examples above, one or more of the networks 103 may include anything from a short, high-speed network (e.g., Gigabit Ethernet or the like) to a simple hardware connection including one or more wires or cables. In still other embodiments where the ML-engine and hardware instruments are in a single location or a few geographic locations, one or more of the networks 103 may transmit the data wirelessly. In other, more intricate deployments of the ML engine, the networks may be complex and configured to exchange data between the various components at high speed.

The processing system 117 includes one or more processors or computers 111, 115, and 119, which may also include multi-processor computers. Depending on their location, the computer systems 111, 115, and 119 may be coupled directly together via a simple wired connection 113, or one or more of the computer systems such as 115 and 119 may be in a different geographical location and thus may be coupled together to exchange data via network 136. Like network 103, network 136 may include a simple wireless or wired network. In other embodiments where the processors or computer systems are distributed, network 136 may involve a complex network such as a metropolitan area network (MAN) or even the Internet. In various embodiments where the Internet is used as a vehicle for the exchange of data between different computer systems, proprietary data is often transmitted using a dedicated cloud-based platform and/or encryption for security purposes.

The processing system 117 may range from a single processor to a large number of identical or disparate processors. While three computer systems 111, 115, and 119 are shown, more or less may in practice be used. In various embodiments, processing system 117 includes a distributed platform of computing devices responsible for executing code for implementing the ML engine, including retraining of the ML training model, controlling one or more hardware instruments as necessary, interfacing with data repository 118, or allowing for authorized users to add to modify, or supplement the computer systems and/or processors with code and data. In an embodiment, processing system 117 may include computer system 111 which may be a standalone personal computer (PC), workstation, or server, or which instead may be integrated with other processors and/or computer systems. Computer system 111 in this example includes three central processing units (CPUs), DRAM, NVM, combinational logic (CL), and one or more transceivers (XCVR). The CL may be a network of integrated hardware logic for implementing various functions in hardware and for interfacing with processors on computer system 111 or on other machines. The XCVR on computer system 111 may be used to exchange data over network 103 or connection 113. Computer system 115 is shown to include a single CPU, along with DRAM, a solid-state drive (SSD) for non-volatile data storage, CL, and an XCVR for exchanging data. Computer system 119 in this example includes a CPU, memory (MEM) which may include DRAM, static random-access memory (SRAM), flash memory, or another type of memory.

Computer system 119 may also include at least one hard drive (HD), which may include one or more magneto-based spinning hard disks or solid-state drives. Computer system 119 may also include one or more CLs and XCVRs.

While the processing system 117 may include general purpose computers or processors along with distinct types of memory and storage, it should be understood that one or more of the functions performed by the processing system may be performed in hardware, middleware, firmware, etc. For example, processing system 117 may include or incorporate one or more digital signal processors (DSPs), application-specific integrated circuits (ASICs), field programmable gate arrays (FPGA), programmable array logic (PAL) devices, systems on a chip (SoCs), and other types of hardware or circuitry for performing functions relevant to the ML-engine and the overall AI system in which the ML-engine is encompassed. The processors included in processing system 117 may include an array of processors, such as complex instruction set computer (CISC) processors, reduced instruction set computer (RISCs) processors, or another type of general or special purpose processor. In one example, computer system 111 may perform all of the retraining functions for the ML-engine, computer system 115 may perform functions relating to allowing users to change the configurations of hardware instruments, convey information to the ML-engine, and retrieve data from the ML-engine, e.g., for use in another processor-based system in processing system 117, etc. In the same example, computer system 119 may perform functions relating to the expert panel, such that all data from the data store 101 is first funneled via networks 103 and 136 to computer system 119 for applying the multi-model expert panel to identify anomalous data prior to using the data for retraining.

The processing system 117 may rely on one or more neural networks, each of which includes interconnected nodes that are inspired by the structure and function of the human brain. In this capacity, the processing system 117, or portions thereof, may include a large number of interconnected processors that act as nodes. These nodes are likened to the human mind in that they are more amenable to recognizing relationships between copious datasets. They are also adaptable, and in this case, they may be used both in retraining an ML model and in the context of the three-model expert panel. Neural networks may be used in a variety of other applications to identify trends, such as financial trends and trends relevant to medical functions within a patient, trends in developing new medications, etc. Thus, the inclusion of neural networks as a main portion of the processing system, whether local or distributed, enhances both the retraining process and the multi-model filtering process.

In yet other embodiments, the functions are not partitioned by computer system. Instead, they may be distributed across one or more computers that collectively perform portions of the relevant functions that make up the ML-engine and all of its connected instruments. Processing system 117 may also be configured to execute code relevant to identifying the necessary measurement types associated with various ones of the tests in the three-model panel.

In sum, the processing system 117 may take many forms, depending on factors like the application in which the ML-engine is involved, the number of locations the AI system is using, and the complexity of a cloud-based platform and associated security of the data transmitted over one or more networks, among other considerations. One exemplary form is a centralized processing system that may include an array of processors that share an identical architecture and that are configured to perform key functions across the array of processors. Such a centralized processing system may include memory such as cache memory for the high speed storage or retrieval of commonly-used data, various types of random access memory, read only memory (ROM), programmable read only memory (PROM), electrically erasable-programmable read only memory (EEPROM), flash memory (NAND or NOR based, for example), and all variations of NVM including SSDs, magneto-based hard drives and the like. In other circumstances, however, such as in an environment where clusters of hardware instruments are spread across a number of locations (such as doctor's offices, car dealerships, financial offices, etc.) and the computing power is also distributed in different locations, processing system 117 may encompass a plurality of disparate computing systems or devices positioned at one location or a plurality of different locations. In some embodiments, processing system 117 may constitute a single processor/memory system, or a small number of networked computers running on a digital cloud platform.

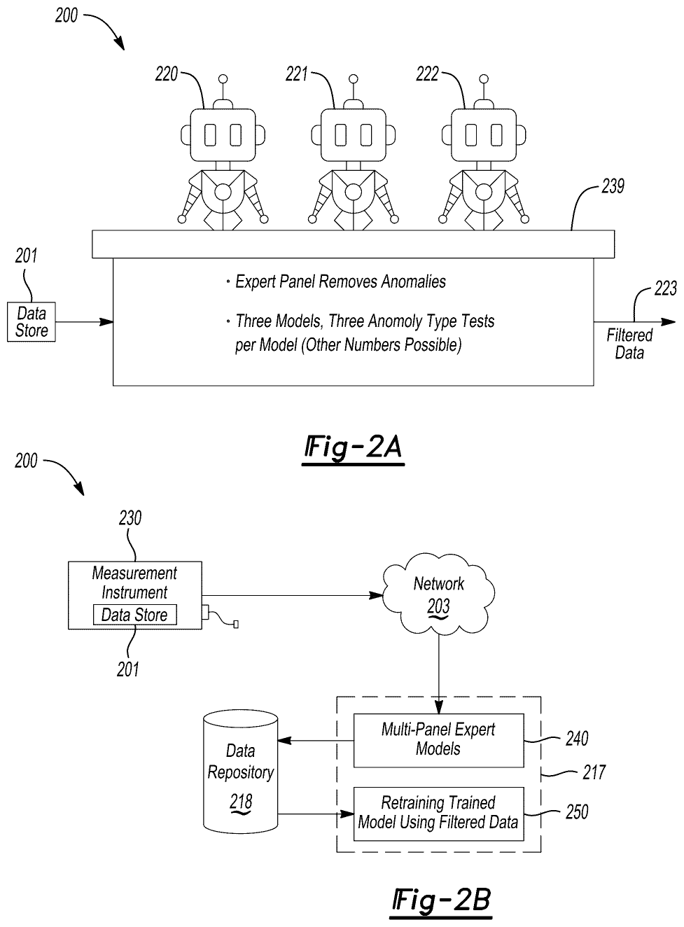

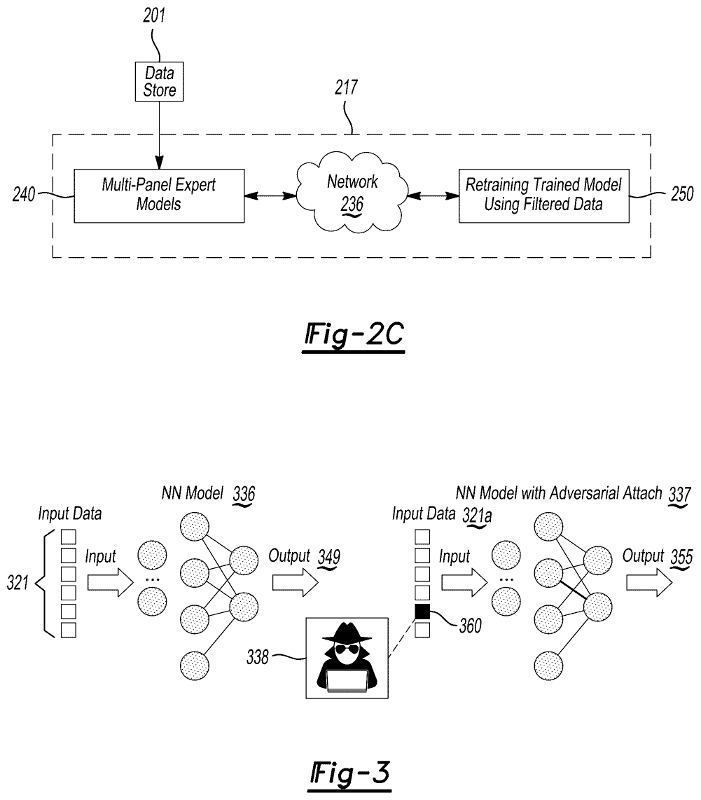

FIG. 2A is an analogous illustration of an “expert panel” 200 including three models for confirming prospective anomalies in the data from the data storage unit (data store) 201. In various embodiments, the data store 201 may include data gathered from a deploy environment (or multiple such environments) which may include a digital cloud platform in which hardware instruments (distributed in different locations or otherwise) collect data from different data sources (e.g., patients in the medical context, or particular anatomical portions of the patients such as the eyes) using the calibrated data from the most recent ML retraining event. In this example, the data may be retrieved from the instruments using the relevant deploy environment. The output data, which may include data from various diagnostic ocular medical centers, is then passed to the expert panel 239. Physically, this means that the data is transferred to the portion of the processing system that executes code to apply the three models represented in the diagram by AI robots 220, 221 and 222 to the data to confirm prospective anomalies. Where potential anomalies of a certain type are identified by a first or second of three tests but a 2oo3 pattern has not yet been established, the potential anomalies are maintained in memory and flagged at least until the relevant tests for that anomaly type are applied by at least two of the three models and the threshold is reached establishing by 2oo3 tests across the three models that the identified data points are in fact anomalies. Thereafter, in some embodiments, the anomalous data is removed from the data input stream (which originated from the data store 201) right away, before the remaining tests on other anomaly types (if any) resume. In other embodiments, all the tests in the three models are first run, with the potential anomalies or outliers flagged in a memory, and the anomalous data (if any) is removed after completion of all tests. Either way, the outlying or anomalous data is filtered (or flagged, at a minimum) from the input data before connection 223 carries the filtered data to a repository or other storage. In those embodiments where the data is not immediately filtered, the information that travels via connection 223 to the repository will include a dataset identifying the anomalies so that they can be removed prior to using the data for retraining of the ML model.

FIG. 2B is a diagram showing another configuration of the ML engine using a distributed processing system in accordance with an embodiment. In this example, the data store 201 is encompassed within a hardware instrument, in this case measurement instrument 230 that also includes a sensor. Like the processing system 117 in FIG. 1, the data store 201 may in some examples may be physically distributed in separate locations before it is ultimately passed to the computational resources within the processing system for application of the three-model expert panel and subsequently, for storage in the data repository 218 for subsequent use in the retraining process.

Unlike in FIG. 1, in FIG. 2A, the processing system 217 is described using logical blocks 240 and 250 that convey exemplary functions of the processing system 217. In the example shown, data store 201 may include measurements obtained from the sensor coupled to the measurement instrument 230. Data store 201, or another memory within measurement instrument 230 may store data obtained from the most recent version of the trained model for use in calibrating the measurement instrument 230 prior to collecting data from the data source. In some embodiments, data store 201 may instead be a memory for storing the calibrated measurement results, and the data from measurement instrument 230 is passed, along with the data from other hardware instruments to a centralized data store (not shown) at a specific location. Alternatively, data from data stores housed in multiple hardware instruments may transmit their data directly to the processing system. In either event, the relevant data is passed via network 203 to that section of the processing system 217 that applies the multi-panel expert models to the data for seeking potential anomalies, filtering out the anomalies that fail 2oo3 of the relevant tests, and sending the filtered data to data repository 218, as shown in general by logic block 240. Thereafter, the data in repository 218 is eventually pulled out for use in retraining the ML model, as shown in logic block 250. The logic blocks 240 and 250 may represent functions performed by executing the relevant code in the processing system 217.

FIG. 2C is a diagram showing yet another configuration of the ML engine using a distributed processing system networked together in a cloud platform. Data store 201 may include data retrieved from various hardware instruments using the ML model, as above. The hardware instruments may be located at a single location or at a plurality of locations. The data is then sent to the processing system 217 where in this example, the processing device(s) that performs the application of the three models (block 240) is physically in a different location than the processing device(s) used in retraining the trained model with the filtered data (block 250). In this embodiment, once the processing device(s) at block 240 completes its tests for anomalies, the data is passed to the retraining processor(s) at block 250 via network 236. As is previous example networks, network 236 may include a singular, proprietary network, or the Internet. In either case, the data may be transmitted securely using encryption and advanced cloud-based logic.

FIG. 3 is a conceptual diagram of a portion of (i) a singular neural network including a model for testing input data in an AI environment and (ii) a malicious actor effecting an adversarial attack on the single neural network at the input by producing subtle fake input data points that are bypassed by the input security as unrecognized.

In the first neural network (NN) model 336, a stream of input data 321 is provided to the NN and since the data is determined to be anomaly-free, the NN system passes the data to the output 349, where it may be passed to a part of the processing system that uses additional NNs for retraining the model.

In the second neural network involving a NN facing an adversarial attack 337, initially a similar stream of input data 321a is provided, e.g., from the output of a deploy environment. In this example, however, a malicious actor 338 has capriciously decided to alter the data in an adversarial attack 337 on the NN model by altering data. The actor can be any person or program with access to the relevant input to the ML model, and in this case specifically to the input data block 360. The adversarial attack involves actor 338, which may be a person with access to the system, or malicious executable code implanted by the person. In this case, to ensure that the attack is sufficiently subtle to bypass the built-in protection mechanisms in the system, the actor 338 may pollute or poison only a limited number of data points represented by the single data block 360 in the example of FIG. 3. Because in this case the input data is subject to a single model and the attack involves only a modest number of data points relative to the data points as a whole, it is assumed that the outliers are missed and not recognized as anomalous. The compromised data is left unfiltered as it passes via output 355 to the next stage of the model, which may be storage followed by use of the poisoned data to retrain the ML model. This outcome can be serious in medical situations, in which the patient data is being manipulated. The erroneous nature of the patient data could lead physicians to the wrong conclusion at a much deeper level.

It is this type of malicious activity that the principles of the present disclosure are designed to prevent.

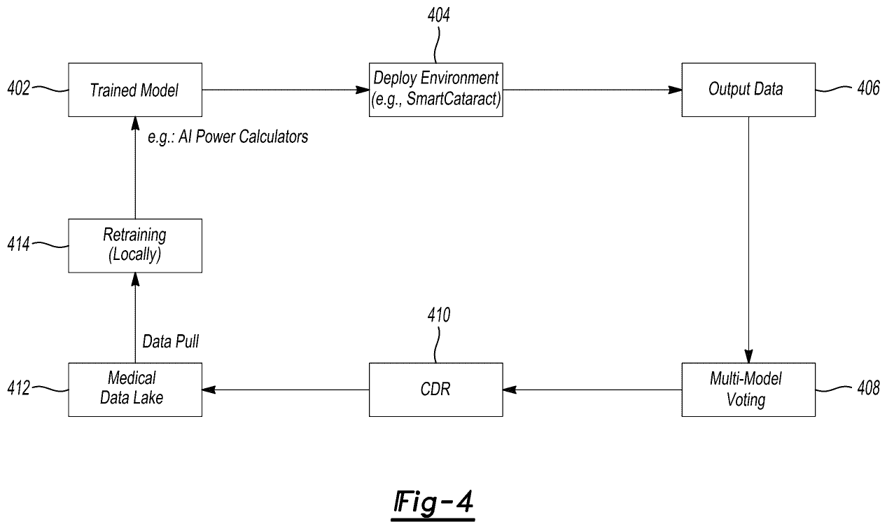

FIG. 4 is a conceptual diagram of a closed-loop artificial intelligence (AI) system including an ML engine implementing aspects of the disclosure. FIG. 4 is an exemplary embodiment in which the expert panel is placed in Alcon's digital solution, such as SmartCataract™ where data is collected from optical clinics and is used for treating various medical or eye-related problems. SmartCataract™ is an application that was designed specifically for ophthalmology, to seamlessly connect data systems, diagnostic devices and surgical equipment, from the clinic to the Operating Room (OR). This helps the AI system operate with greater efficiency, flexibility and accuracy. The diagram shown in an exemplary ophthalmology context may be run on a comprehensive cloud-based Digital Health Solutions (DHS) platform that enables all authorized clinicians, physicians, and other authorized personnel to access the data from anywhere, such as by using one or more of the networks 103 in FIG. 1. SmartCataract™ is one of Alcon's Smart Solutions applications, which means that SmartCataract™ or a similar application is part of the deploy environment 404 of the ML-engine. SmartCataract™ is used in Alcon's cloud-based platform uniquely designed for surgical ophthalmic practices. The deploy environment 404 can therefore use the integrated platform of Smart Solutions to employ SmartCataract™ to automatically evaluate patient data by taking into account surgeon's preferences, preferred formulas and lens types to guide a surgical planning stage, for example, including in patients that suffer from type 2 refractory diabetes and/or eye-specific maladies. Thus, in this AI example, data is collected at clinics from optimized hardware instruments with sensors that probe or contact the data source (e.g., a patient or his or her eyes). Once the data is obtained from the data sources, the application will be added on top of the data—that is, layered on top of the digital products. In this respect, the data will be one application added to any of Alcon's digital products, whether implemented locally, in the cloud, or otherwise. The output data 406 may be transferred in some embodiments to a centralized location, such as a data store 201 (FIG. 2). The output data 406 may also be transferred to a plurality of data stores. In cases where the data remains in a hardware instrument or any of Alcon's digital products, the data stores may be construed to include the locations where all the relevant layered data resides.

Continuing with this exemplary embodiment, the output data 406 is transferred to one or more memories in the processing system where the multi-model panel 408 resides to examine the incoming data and test its data points for anomalies, whether due to unintended data points, inaccuracies, or malicious activity from an actor, e.g., by way of an adversarial attack. Referring to FIG. 4, the panel 408 is placed in the ML-engine loop between the output data 406 and the CDR 410 (see below) to help ensure that no anomalies are used to retrain the trained model 402. In the embodiment of the three-model panel, the processing system confirms the presence of possible anomalies in the data using three models, each model including three tests for detecting three respective anomaly types in the data. The processing system sequentially applies each test for detecting prospective anomalies that appear within a configuration of the data relevant to the test currently being run. The filtering further includes detecting, for each anomaly type, the prospective anomalies using at least two of the three tests in the three models as a threshold for determining whether the data includes anomalous data corresponding to the anomaly type. Whether using code in the processing system or hardware included therein, the processing system filters the anomalous data from the data when corresponding tests from at least two out of the three models in the panel 408 identify the same anomalous data for the pertinent anomaly type. Each of the models may be associated with three different filters for filtering the three different anomaly types from the data.

After the panel 408 runs its tests and extracts the malicious, inaccurate, unintended or fake data points from the remainder of the data, the processing system transmits the data to a clinical data repository (CDR) 410. The CDR 410 may be a database of non-volatile memory for storing the filtered data for subsequent use in retraining the trained data model. Unlike conventional techniques, the CDR 410 only stores data where a high degree of confidence exists that the data lacks anomalies. The CDR 410 may be located within the digital cloud platform for security and ease of control but may be elsewhere in other embodiments.

In some alternative embodiments, when the 2oo3 finds anomalies, the panel 408 flags the malicious data but sends all the data (along with the flagged information) to the CDR. Thereupon, the processing system filters the data and removes the anomalous data points before the data travels further down the loop.

As noted, each test run by panel 408 for a particular anomaly type can include an ensemble of tests or measurements to determine the presence of the anomaly, which further increases the reliability of the test results. Exemplary tests and measurements are described in greater detail below.

Referring still to the embodiment of FIG. 4, the filtered data in the CDR 410 is then passed to the medical data lake 412, directly by a wired connection or via the secure, cloud-based network. In other AI applications, this database feature may not be used, or it may be referred to by an appropriate name. Medical data lake 412 is a database that is used to provide the clean data for retraining. As indicated, the retraining 414 may be performed in a geographic region local to the medical data lake and the trained model 402. That is to say, the retraining 414 code/logic within the relevant portion of the processing system may be local to the medical data lake 412. Because the data has been filtered of anomalies, a high degree of confidence exists that the retraining (logic block 414) will occur only using accurate data, ensuring a high degree of confidence in the retraining 414.

When available, the retraining 414 performs a data pull that extracts a block of data, or a data stream as the case may be, from the medical data lake and uses the pulled data to retrain the trained model 402. The trained model 402 may include NNs in which the data relevant to the AI type at issue is embodied. The retraining 414 may involve using the data in a variety of contexts and a set of techniques, such as an AI power calculator for making statistical assessments (e.g., of patient data) and making calculations on data sources. As an example, in the ophthalmology field, AI power calculators may be used for performing calculations relevant to what kind of lens is compatible with the eyes of a particular patient. The use of a power calculator in the ML engine allows for calculating probabilities of error rate and other attributes, taking into account factors such as sample size, confidence in some outcome, mean and median errors, and the like. In the field of ophthalmology, an intraocular lens (IOL) is a monofocal lens that may be used clinically on patients, with an IOL calculator using the measured data ranges to provide information for the patient's treatment and to determine whether a given input data to the panel 408 is an anomaly. Many different ML techniques for retraining the trained model 402 can be used without departing from the spirit or scope of the disclosure. The trained model 402 may be in the cloud platform and may physically reside in a local NVM included with the processing system.

Once the trained model 402 is retrained using the data pull from the medical data lake 412, the newly retrained data is transmitted via network back to the deploy environment, where the data may be provided to a surgical hardware instrument (e.g., one that performs cataract surgery) in the deploy environment 404. The newly trained data may be sent to any number of hardware instruments in the deploy environment to which the data is relevant, and to several clinics or hospitals. The data may also be sent to the files of a particular patient, such as a person whose eyes are a data source from which sensor measurements were taken. After more measurements are taken or actions are performed, the updated machine and patient data may be sent again to the data store where the output data 406 resides. The closed loop may continue as more data is aggregated from new data sources.

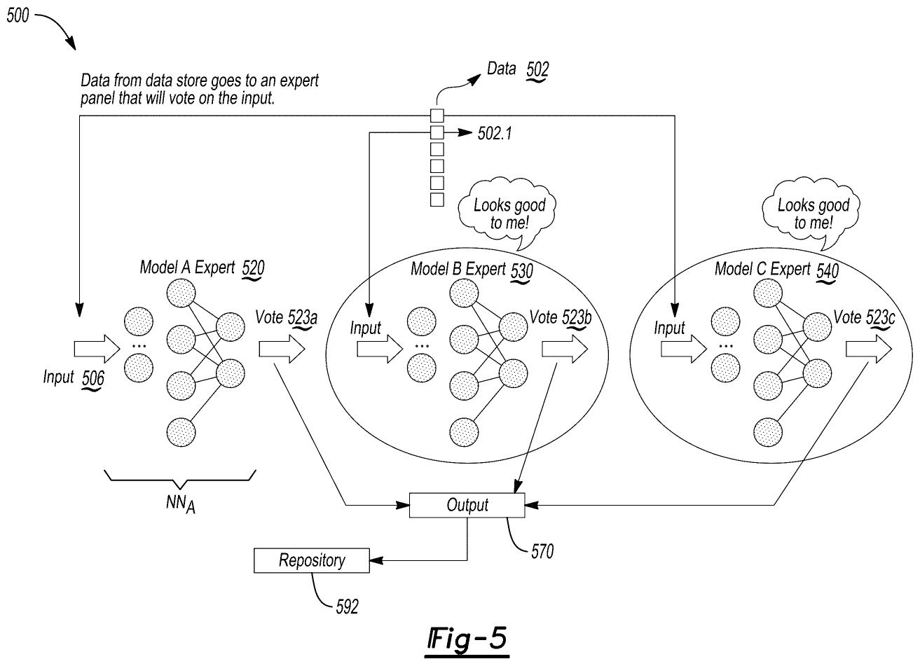

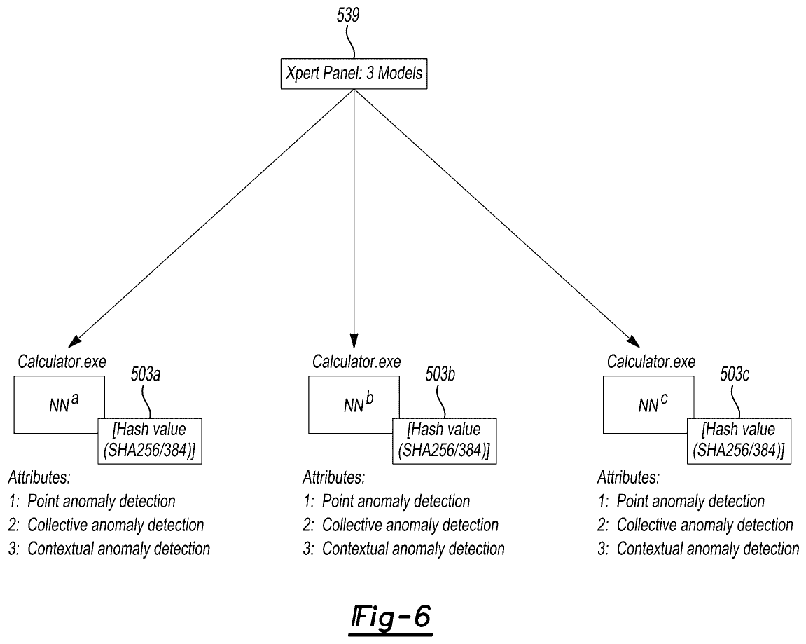

FIG. 5 is an illustration of an expert panel 500 including three models 520, 530, and 540 (obtaining data 502 from at least one data store holding the output data 406 of FIG. 4) for evaluating input data for outliers or other anomalies, in accordance with an aspect of the disclosure. Each model may include a separate NN (e.g., NN_{A}) in which, for one such model, three tests for three distinct types of anomalies are formed as one or more NNs. The NNs may be formed using executable code in the processing system. Initially, the data source originates from a deploy environment (or other location if a cloud-based platform is not used), and is sent using any suitable protocol (e.g., streamed, transmitted in IP packets, etc.) to the expert panel 500 inputs. The data blocks 502, including data block 502.1, may be sent to the inputs (e.g., input 506 for model A expert) of any of the models denoted model A expert 520, model B expert 530, and model C expert 540. In the example shown, data 502 is sent to either model A expert 520 or model C expert 540. The next data block 502.1 is sent to model B expert 530. In various embodiments, the transmission of the various blocks of data in data 502 is performed sequentially. For example, the first block of data 502 may be sent to the input 506 of model A expert 520. If one of the tests in model A expert 520 detects an anomaly, NN^{A} sends the test results to the input of model B expert 530 and/or the output 570 using the vote path 523a. The test for the same anomaly type is conducted at model B expert 530 and if necessary (e.g., no anomaly is detected by model B expert 530, as indicated by the “Looks good to me!” quotation adjacent model B expert 530), the NN for model B expert 530 sends the data and test results for that anomaly type (1 pass, 1 detected anomaly), via vote path 523b, to model C expert 540 and/or directly to the output 570. The NN of model C expert 540 evaluates the data using an analogous, albeit different, test including one or more relevant measurements. As shown by the “Looks good to me!” quote that is adjacent model C expert 540, the NN of model C concludes that no anomalies of that type are present. model C expert 540 casts a “pass” vote, and the NN for model C sends its test results via vote path 523c to output 570. For that particular anomaly type, only one (not the required two) of the tests concludes that anomalies of that type are present in the first data block from data 502. The aggregate test results for each of the models for the first anomaly type is completed for that data block, and the data block from data 502 is sent “as is” to the repository 592, because no filtering of data for the first anomaly type is needed.

After the three tests are completed, the models resume. Model A expert 520 may proceed to perform the second test on the first data block. If NN^{A} concludes that there are no point anomalies of that type upon executing the second test, then it sends a “pass” notification and details of the applicable data block to model B expert 530 and/or to the output 570. The output 570 is useful for keeping track of the data and any anomalies, including any 2oo3 detected anomalies. The second test is then performed by the NN of model B expert 530. If both Model A expert 520 and Model B expert 530 determine that there are no anomalies of the second type, it becomes unnecessary to perform the second test at model C expert 540 (although this latter test may be performed in some embodiments simply to collect more data on risk assessment issues.) This is a substantial benefit in performing aspects of the disclosure. If 2oo3 tests identify the presence of anomalies of that type in the (second or) third model. This is because the 2oo3 test has already passed for those anomalies, and further usage of bandwidth with respect to the remaining model and test becomes unnecessary. Thus, for example, if models two and three detected anomalies of the particular type being sought, the security algorithm can simply proceed to the next anomaly type and model 3 can ignore executing the test for the detected anomalies of that particular type. In essence, this shortcut takes a hardware algorithm and executes it more efficiently by obviating the need for a real time test using the third model. The net result is a cumulative and potentially dramatic increased speed of the hardware test for anomalies while maintaining the integrity of the test's conclusions, all the while doing so by reducing otherwise needed bandwidth. This test has a cumulative nature, in that the longer the multi-model test is run, the more data will be saved and the better the processing system (or hardware functions) will perform. The aspects herein, at a minimum, entail appended claims not only solving significant technological problems present in all types of cloud platforms, which are problems that persist and even worsen to this day, but more importantly the tests improve efficiency or operation of a computer and other technology described herein by saving more bandwidth over time as the model is continuously retrained.

Whatever the result, the information, any anomalies, and the data at issue are provided to the output 570. It is noteworthy here that if either tests 2 or 3 had found 2oo3 anomaly types for the first data block of data 502, then the data previously sent “as is” from test one may be modified at the output 570 or the repository 592 to filter the second or third anomaly types from the data. In other embodiments, the later test results may simply replace and supersede the existing data with filtered data accounting for detecting any anomaly types.

After the integrity check on the first data block is complete, the processing system may send the next data block 502.1 to one of the models. While in some examples, data block 502.1 is sent to the first model, this need not be the case. In this example, the data block 502.1 is sent to the input of model B expert 530. The testing resumes on data block 502.1 as the models sequentially apply the respective tests for anomaly type detection. The sequential nature of the test stems from (1) the different models separately and sequentially running the three tests in the case where no anomalies of any type are found, (2) a test for a specific anomaly type that is identified, e.g., in model A expert 520, which causes the analogous test for model B expert 530 to run in sequence on the data. If model B expert finds an anomaly of the same type 530, then 2oo3 of the tests find anomalies, rendering the analogous test at model C expert 540 unnecessary. If instead model B expert 530 finds no anomalies of the same type when executing its test, then control passes sequentially to model C expert 540, which “breaks the tie” by finding that the data is allowable (no anomalies found) or instead that the data includes anomalies of the type at issue. In the latter case, 2oo3 of the tests conclude that anomalies are present, which subsequently are filtered from the output 570 or the repository 592.

Other aspects may be contemplated wherein one or more of the models or tests can be simultaneously active. This possibility is deemed to be a variation on an embodiment and is within the scope of this disclosure.

FIG. 6 is an illustration of a three-model expert panel, each model testing for three attributes according to an embodiment. The logic for the “Xpert Panel” of three models 539 is illustrated. In case an ML model is trained to output a static vector, such as in the case of a power calculator, the input variables can be flagged as real or fake following the three anomaly detection tests within each model. In this embodiment, the same executable code is used for all three expert models, with the anomaly detection logic built in. The anomaly detection tests include three anomaly types: point, collective, and contextual.

Each model therefore is associated with three neural networks styled NN^{a}, NN^{b}, and NN^{c}. Each of the models has point anomaly detection logic, collective anomaly detection logic, and contextual anomaly detection logic. To ensure each of the models NN^{a}, NN^{b}, and NN^{c} has not been tampered with, each of the models NN^{a}, NN^{b}, and NN^{c} is associated with an SHA-256/384 hash value for integrity verification, where SHA stands for Secure Hash Algorithm, and 256/384 corresponds to the strength indicated by the number of bits. In the case of SHA-256, the number is 32 bytes/256 bits, where SHA-384 is 48 bytes/384 bits. Thus, NN^{a} is associated with hash value 503a, NN^{b} is associated with hash value 503b, and NN^{c} is associated with has value 503c. These security measures are one source of protecting the three models 539 from being corrupted. More controls are used to ensure that the expert panel of three models 539 has individual integrity verification for each model NN^{a}, NN^{b}, and NN^{c}.

Because the models in FIG. 6 operate on an “either or” basis, in other embodiments, the anomaly detection tests can be associated with individual models. As an example, NN^{a} can be point, NN^{b} can be collective, and NN^{c} can be contextual.

In various embodiments, the executables (or hardware-implemented models as described above) are not identical. They may have the same signature (i.e., they are identical in integrity inasmuch as the models have not been compromised). However, in these embodiments, each of the models NN^{a}, NN^{b}, and NN^{c} have different logic for each of the three filters, meaning the three models each have different models seeking to detect the same anomaly type (e.g., contextual anomaly, etc.) but the tests in the different models may use a different measurement types to establish the presence or absence of the relevant anomaly type. For example, the executable file “Calculator.exe” may include a variety of subroutines that are used for specific tests. The file may also call different dynamic link libraries (DLLs) to perform distinct functions for separating the models.

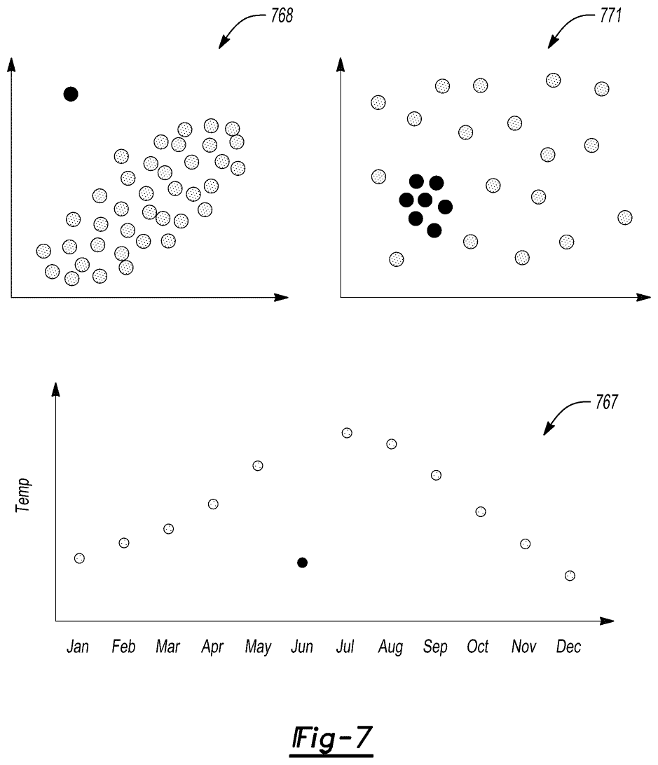

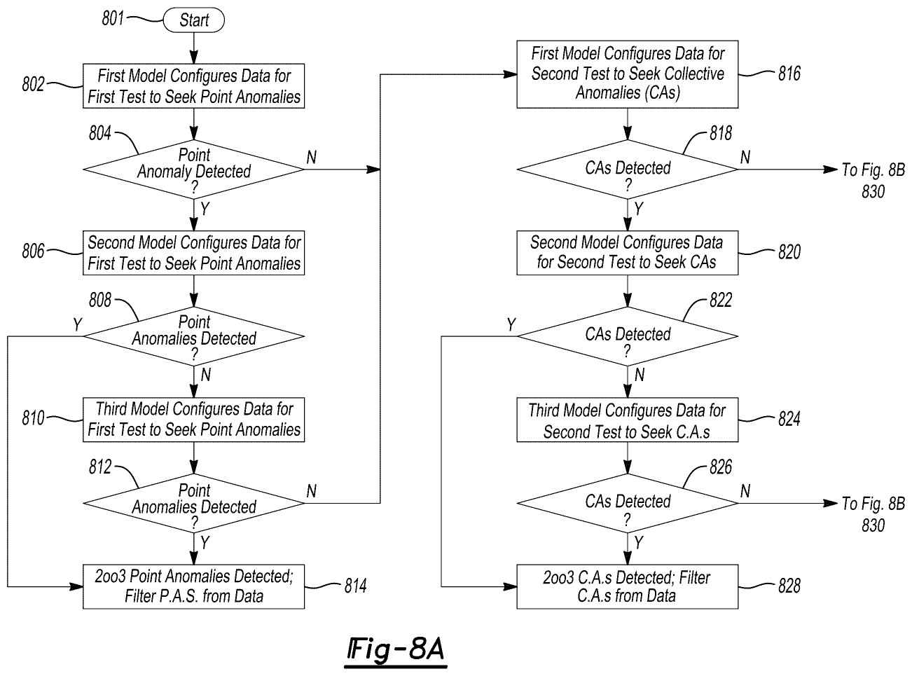

FIG. 7 is a graphical example of outliers in each of three anomaly types, including tests for point anomaly types, collective anomaly types, and contextual anomaly types. In actuality, in most ML applications, the data being dealt with is multi-dimensional. Therefore, for visualization purposes, the multiple dimensions are compacted into a graph with two axes. That is, for each anomaly type, the principal axis is identified, which enables the processing system to project the multi-dimensional data into two dimensions. The axes are often not labeled because they are just compacted from multiple data points of a high dimension to two dimensions.

Referring to FIG. 7, graph 768 shows an example of a point anomaly in the data. The point anomaly is the data point in black and represents an obvious anomaly. It should be borne in mind that, in the hospital/medical examples in which patient data is being considered, the black point represents one patient that does not fit the distribution. Rather than being a single piece of data, the black point and the other non-point anomalous data points each represent a collection of features relevant to a patient. In an analogous ML example, one such feature may be credit card transactions. If an individual hits the limit, that person will be tagged as an outlier. In this example, the features may be the number of credit card transactions, but the black dot is indicative of the one instance of the transactions exceeding the limit (the clear point anomaly).

This approach follows a filtering logic. In the above example, if there is obviously a point anomaly, in some implementations there is no need to proceed. While the filtering logic may not be employed in many embodiments, it allows the ML engine to be efficient. Technically, in accordance with an aspect of the disclosure, even if the ML engine does not stop at one obvious anomaly, the 2oo3 approach means that the third test is not necessary, and that the anomaly can be flagged as detected. In another example of the benefits of the filtering logic, each test for an anomaly type in a model may as noted be an ensemble of tests for confirming to detect the single anomaly type. An ensemble of tests or techniques can be used provided that the techniques are in the same category as the anomaly type. For example, the point anomaly test may use an ensemble of point anomaly techniques.

Referring still to FIG. 7, in the collective anomaly type identified by the data points in graph 771, the black dots as a whole are collective outliers or collective anomalies. As usual, the applicability of the anomaly types depends on the nature of the AI system. Graph 767 is an example of a contextual anomaly. Since the context is time, and more precisely, month of the year, the principal axis of graph 767 can be labeled based on the context. As shown, the data points follow a semi-triangular or Gaussian curve pattern. The black data point at June is plainly inconsistent with the trend of the rest of the data points. Thus, a strong possibility exists that the black dot is a contextual anomaly.

FIGS. 8A-8B are exemplary flow diagrams describing illustrative test procedures for detecting three anomaly types in a three model input system, according to an aspect of the disclosure. These tests are but one example in a series of viable logical flows that can be used to reach a similar result The steps identified in FIGS. 8A-8B may be performed by the processing system running executable code as described in FIGS. 1 and FIGS. 2B and 2C. In some embodiments, the processing system may partly include one or more hardware elements or special purpose devices configured to perform relevant functions. They may include DSPs, ASICS, FPGAs, PALs, programmable logic arrays (PLAs), SoCs and the like. In implementing the tests, the models may obtain data from a power calculator and other devices' measurements. FIGS. 8A-8B represent one of several embodiments in using the three models and associated tests to sequentially detect anomalies.

Referring to FIG. 8A, the expert panel may be activated (START 801) by incoming data that was previously output from a deploy environment and temporarily stored in one or more local memories within the portion of the processing system that emulates the models. Once the incoming data arrives at the first model, the first model at logic block 802 configures the data for the first test to confirm potential point anomalies (PAs). If no PAs are detected at decision block 804, then the first model at logic block proceeds to configure the data for its second test (or ensemble of tests) to confirm any collective anomalies (CAs). Once those tests are performed, the first model at decision block 818 determines whether it detected any CAs. If no CAs are detected, reference is then made to FIG. 8B at logic block 830. The first model configures data for its third test (or ensemble thereof) to seek contextual anomalies (Cxt As). If at decision block 832, the first model determines that no Cxt As are present, then the first model has completed all of its tests for the input data at issue and control proceeds to logic block 844. There, the second model configures data for the third test to confirm possible identities (Cxt As.) If at decision block 846 the second model determines there are no Cxt As, then control passes to logic block 848, where the tests for the input data block at issue are concluded. Control passes back to logic block 802 of the third data block for the first model to run its first test on the next data block in line.

The above scenario presupposes for simplicity that the expert panel encountered no anomalies of any type. The next example addresses, referring still to FIGS. 8A and 8B, the logical flow when various tests from models encounter anomalies, and even disagree over them. Referring back to decision block 804, it is assumed this time that prospective PAs have been detected by the first test in the first model. This time, instead of staying with the first model, the other models will be consulted to determine whether they detect the prospective PAs. Thus, where PAs are detected at decision block 804, then at logic block 806, the second model configures the data for its first test to seek the presence of PAs. If at subsequent decision block 808 the PAs are detected, then the ML engine passes control to logic block 814, having determined that 2oo3 of the tests have identified PAs from the data at issue. In this event, there is no need to consult the third model since the first and second models have already identified the PAs. As such, the anomalies are flagged, and the data will be filtered to remove the identified PAs.

In an alternative scenario at decision block 808, in the event that the second model's test does not identify PAs, then the third model is relevant to “break the tie.” At logic block 810, the third model configures the data for the first test to confirm prospective PAs. In this case, the test is conducted, and if at decision block 812 the PAs that were earlier detected by the first model are currently detected by the third model, then logic block 814 is reached again, the first and third models having detected the anomalies. There, 2oo3 tests are deemed to identify and flag the PAS, and the data will be filtered to remove them.

Sticking to the same scenario, if instead at decision block 812 the third model's test does not find the PAs, then only one of the three tests from the respective three models identified possible PAs, which means that the 2oo3 criterion is not met and no PAs are presumed in the data. Thus, control passes to logic block 816, and the first model moves on to configure the data to confirm potential prospective CAs, as described above. In this example, at decision block 818, it is assumed that the first model detects one or more CAs. At logic block 820, the second model is invoked to configure the data for performing its test (which, like the models of other tests, may include one or more sub-tests or measurements). Referring to decision block 822 of FIG. 8A, it is determined whether the CAs are detected. If so, then as noted at logic block 828, the ML engine has determined that 2oo3 of the models have identified the CAs. Thus, the detected CAs will be flagged, and filtered from the data.

If instead at decision block 822 the test of the second model does not detect any prospective CAs, then at logic block 824, the third model is invoked to perform its CA test. Then, at decision block 826, if the CAs from the first model are detected, the ML engine determines that 2oo3 of the tests identify CAs, as the first and third test found the CAs. The CAs will be filtered from the data. If, conversely, the third model finds no CAs at the third model at decision block 826, then the data is deemed CA-free for the purposes of the tests, the conclusion may be stored in an output memory (e.g., output 570 or repository 592 of FIG. 5), and the flowchart moves to logic block 830 in FIG. 8B. The PAs and the CAs having been dealt with, the ML engine sequentially invokes the first model, which configures the data for the third test to confirm prospective Cxt As, as described above. At decision block 832, it is now assumed that the test in the first model identifies one or more Cxt As. Then, at logic block 834, the ML engine invokes the second model, which configures the input data for the third test to confirm prospective Cxt As. If the second model, via the third test, detects the Cxt As at decision block 836 that were detected using the first model, then at logic block 842, the 2oo3 test confirms that Cxt As are detected and will be flagged and filtered from the input data being examined. If instead at decision block 836 the third test of the second model fails to detect Cxt As, then the third model at logic block 838 is invoked to break the tie. If the third model, via the third test at decision block 840, detects the presence of the Cxt As, then the 2oo3 test applies at logic block 842 since the first and third models identified the Cxt As. The Cxt As will be filtered from the data.

If instead the third test of the third model fails to identify any Cxt As, then at logic block 848 the tests are deemed complete for the input data being examined. The tests can then resume for the next data block or data stream that is input from the deployment environment, and as such, control returns to logic block 802 of FIG. A.

In some examples above where the anomalies of a particular type were detected using respective tests from the first and second models, it was unnecessary for the ML engine to invoke the third model, since the first and second models were sufficient to detect the Cxt As. This embodiment advantageously speeds up the test process and helps ensure real time data protection. However, if only one of the respective tests from the first and second models detected Cxt As, then it becomes necessary to perform the test for that anomaly type using the third model.

It is noteworthy that after logic blocks 814, 828 and 842 where the 2oo3 determination was made and that the relevant data point(s) would be filtered from the data, control simply returns to the next anomaly type at issue in a sequential manner. If at logic block 842, the tests are all complete, then the next input data block can be examined at logic block 802.

It should be understood that the above routine is exemplary in nature, and other ways to detect the relevant anomaly types are possible. For example, the test need not begin at the first model. In other examples, certain of the processes described above can be performed in parallel. Thus, the above sequential application is merely an embodiment, and other ways to use the models to detect the pertinent anomaly types are within the spirit and scope of the present disclosure.

In short, existing or proposed security systems and applications fail to provide the users with any proof that the training set of the data can be trusted. The aspects of the present disclosure, however, allow the user to build the expert panel progressively, over time to ensure that the data is not malicious. The need for data integrity typically increases along with the set of training data. In the medical field, the consequences can be an increase in patient safety and treatment efficacy. For example, in an embodiment, different tests from different filters may be performed simultaneously. This embodiment and variations thereof can substantially increase the speed of the monitoring process.

Referring back to the tri-model ML engine, the expert panel also addresses two key considerations: AI bias and explainability. Considering the first topic, AI bias in the overall protection scheme is one of the key factors for this multi-model implementation. The expert panel inherently addresses bias as part of AI algorithm development. For example, in this and other multi-model embodiments, the expert panel is based on a multi-party consent approach such that all experts in the panel have the same signatures. The fact that the models have the same signature does not make them identical in substance; rather, they are merely considered analogous or identical with respect to their associated data integrity capabilities. Accordingly, the 2oo3 voting logic acts as a bias monitor. Each model of the three models may be distinct. For this reason, there no longer exists one single model for the decision, which historically has been known to introduce bias in existing implementations. One simple example of this bias is that, in proposed and existing applications, a single model often uses a single function that repeatedly makes the same decision for a given input. In these approaches, context, history, and other factors are ignored, which increases the potential that the model may pass unauthorized or malicious data into the retraining and ML portions. Accordingly, because it uses multiple different models, the expert panel is designed to removes bias in the AI algorithm. In some embodiments, the biases are more sophisticated, but they may be addressed in a comparable way, with multiple input models considering the incoming data from unique perspectives.

Because each expert has point, collective and contextual anomaly detection signatures, this creates a filtering logic not just between experts as in eliminating biases, but also the filtering logic may be within each of the experts.

The second topic is the explainability of the AI decision to allow certain input data and to disallow other data. Explainability is key for users interacting with AI to understand the AI's conclusions and recommendations. With this approach, using multiple models, the expert panel decisions may be made interpretable and easily explainable.

The expert panel helps protect AI products from adversarial attacks and reduces the risk of anomalous data including fake, deceptive, or malicious data being introduced into the products. In the medical AI field, this innovation supports patient safety while protecting the AI-based products from being compromised from both an integrity and availability perspective. Each expert/model in the panel has attribute signatures for distinct anomaly detection and works alongside other experts in the panel. Each expert has point, collective and contextual anomaly detection signatures in which biases are filtered from three corresponding tests. The multiparty consent model allows the panel to detect inaccurate, malicious, and potential fake data while removing bias from the system.

The expert panel may be both in digital products and any other tools where there is a mechanism for user input data to be captured. The expert panel can be used as a filter prior to any key decisions being made across critical infrastructures (e.g., Utility, Automotive, Health, etc.,) where machines are driving the decisions.

Several types of attacks on neural networks have emerged in recent years. The multi-panel solution described herein can address and identify these attacks. They include: (1) data poisoning, where the data training sets are poisoned from ML models that are often trained on data from potentially untrustworthy sources (for example, a malicious actor attempts to modify or corrupt data or to insert backdoors or trojan horses into the dataset); (2) adversarial attacks on model data inputs.

In further embodiments, the expert panel can be extended beyond static vectors. For instance, Optical coherence tomography (OCT) is an imaging technique that uses low coherence light to capture micrometer resolution, two and three dimensional images from within optical scattering media (e.g., biological tissue). OCT images entering into AI-based digital optical solutions can likewise be evaluated for quality assessment, e.g., using a secure cloud in some embodiments.

OCT images may be considered a potential anomaly category, independent of eye-related anomalies. In an aspect of the disclosure, the ML-engine extends beyond the expert panel to include an augmented expert panel, which may be triggered when an OCT image is received. The augmented expert panel in one embodiment includes three separate models. Each model of the augmented expert panel includes three tests (or ensembles thereof): (1) an image aesthetic assessment, where the processing system executes code that examines the image based on relevant criteria to confirm that the image is representative of the typical aesthetics of the relevant data source (e.g., the patient's eye-related measurements); (2) an image impairment assessment, to determine whether historical measurement data or various ranges of variables establish whether the image has been manipulated or the quality of the image has been intentionally reduced, and (3) an artifact visibility assessment, in which the models in the augmented expert panel examines the image to detect any inaccurate or fake artifacts that were maliciously added to the image. In an embodiment, the augmented expert panel may include three models, each model having the above three assessments such that the expert panel can vote on whether OCT-based anomalies of one or more of the assessments are present based on a 2oo3 vote.

Turning to the details of the tests run by the various models in the expert panel (e.g., tests for point, collective, or contextual anomalies), the details thereof are entirely dependent on the application undertaken. For example, the tests for a financial AI system will be different from the tests for a medical or ocular application. To provide detail in an exemplary AI system directed to ophthalmology, certain tests that can be run to detect the presence or absence of a relevant anomaly type are described. In the field of ophthalmology, the tests for seeking anomaly types may include specific detection techniques that the models can use based on the existing data accessible to the processing system, which may include various sub-tests and measurements. As noted, each test may include an ensemble of tests or measurement results used by the model to detect whether a specific anomaly type is present. In other disciplines, such as the use of AI systems and ML in other medical fields, the use of ML for predicting financial patterns, and many others, this list will be different, and specific to the ML field in question. Whatever the discipline, a table of measurements or anomaly-detection techniques can be used.

In another aspect, a non-exhaustive list of measurement data that can be used to enable the models to mark the presence of a specific anomaly type in the field of ophthalmology and the presence or absence of point anomalies (PAS), collective anomalies (CAs), and contextual anomalies (Cxt As), is set forth in Table 1, below.

TABLE 1
Examples of ocular detection types available to the panel models

| | Point | Collective | Contextual |
|---|---|---|---|
| Anomalies Related To: | Anomalies | Anomalies | Anomalies |
| White-To-White (WTW) | ✓ | ✓ | ✓ |
| K-Readings (K-Steep, | ✓ | ✓ | ✓ |
| K-Flat) | | | |
| Anterior Chamber Depth | ✓ | ✓ | ✓ |
| (ACD) | | | |
| Axial Length | ✓ | ✓ | ✓ |
| Not-A-Number (NaN) | ✓ | | |
| Overflow/Underflow | ✓ | | |
| Numbers | | | |
| Pre-op Sphere, Cylinder, | ✓ | ✓ | ✓ |
| Spherical Equivalent | | | |
| IOL Power | ✓ | ✓ | ✓ |

Many of the foregoing measurements are performed by IOL power calculators. IOL calculators use clinically-obtained data ranges and measurements to define whether a given input data is an outlier (anomaly) or not. For instance, with reference to Table 1 above, this data is clinically obtained from data sources (here, one or more eyes or adjacent anatomical regions of a patient). The data sources and measurement results can be routed from their current data store as discussed above and thereafter used in one of the three tests to detect anomalies. Some exemplary references to the table entries include:
1. White-to-white (WTW) distance, which gives the horizontal cornea diameter, is expected to fall between 8-14 mm for a normal eye.
2. Corneal curvature estimates, KSteep and KFlat (Keratometry (K) readings) are expected to fall within 30-60 degrees. K readings quantify the measurement of corneal curvature, the latter of which determines the power of the cornea. K readings including Ksteep and KFlat are used for intraocular lens power calculation in cataract surgery, among other applications in ophthalmology.
3. Anterior Chamber Depth (ACD), which is the distance from the posterior cornea to the anterior lens surface is expected to have the range 0-6 mm.
4. Axial Length (AL), which is the distance from the cornea to the retina, is expected to have the range 12-38 mm.
5. Not a Number (NaN) is a value of a data type which is undefined (e.g., infinity, a quantity involving division by zero, or another nonsensical value in light of the context).
6. Overflow/underflow numbers occur in various circumstances/calculations where the calculation produces a value that is outside of the defined or measured range of the variable at issue.
7. Pre-op Sphere, Cylinder, Spherical Equivalent: refers to pre- and postoperative refractive outcomes of a sphere or a similar shaped object. The operation may involve cataract surgery, for example.
8. Intraocular Lens Power (IOL Power) refers to a calculation using various ocular values, where the calculation is to provide an IOL lens matching the characteristics or objectives of a patient or the patient's eyes.
9. Lens Thickness (LT), which is the thickness of a patient's natural lens is expected to be within 2-8 mm.

This is just an example of measurement types, and others may be equally relevant for purposes of the expert panel analysis. With reference to the ranges mentioned above, any measurement outside these ranges would be caught by the ML engine and its models as an anomaly.

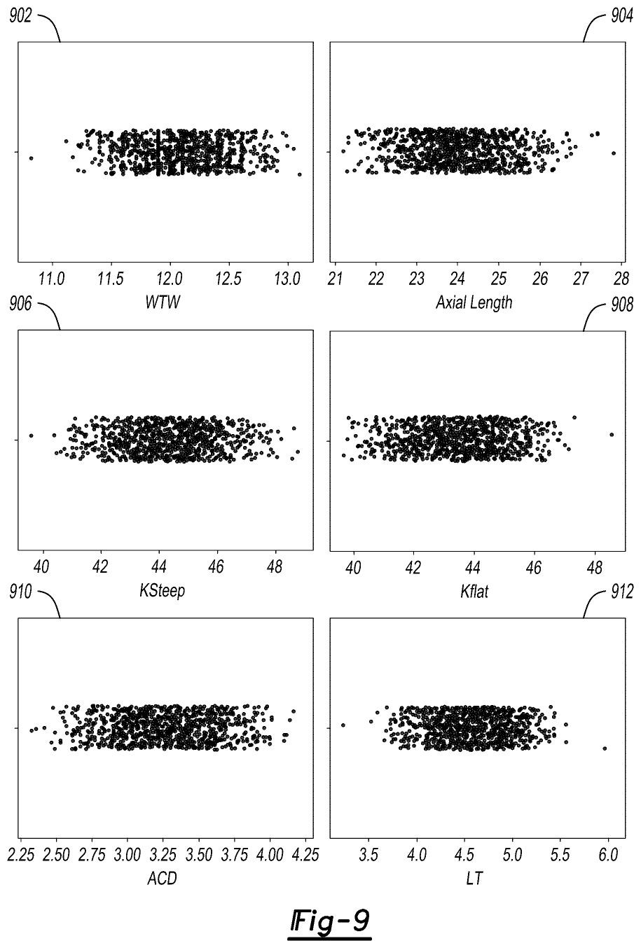

FIG. 9 illustrates diagrams of data measurements that illustrates typical input parameters to an IOL power calculator, and that a test for a particular anomaly type may use in seeking anomalies. The measurements may be retrieved from the deploy environment as part of the overall data input into the ML engine for prospective filtering of false, malicious, or flagrantly inaccurate data, however caused (i.e., anomalies). As noted above, the WTW distance is expected to fall between 8-14 millimeters (mm) for a normal eye. Referring to graph 902 of FIG. 9, which represents WTW distance and in which the horizontal axis represents millimeters (mm), it may be concluded that all data points are within range, and, for this particular example, there are no anomalies.

The graph 904 represents axial length with the horizontal axis in mm, and the above-cited range is 12-38 mm, meaning that these data do not give rise to the presence of outliers. Graphs 906 and 908 represent respective K values KSteep and KFlat. Here, the horizontal axis represents degrees, and the data points in this case all fall within the above-cited range of 30-60 degrees. Graph 910 refers to ACD having its horizontal axis in mm. The ACD data points fall within the above-cited range of 0-6 mm, and no anomalies can be deduced in this example. Graph 912 refers to LT having a horizontal axis in mm and falling in range of the 0-6 expectation value.

While each of the above data measurements appear to comport with authentic data values, it should be borne in mind that some anomalies are hidden from conventional security techniques. For example, there are instances where there are no outliers detected when each input parameter is taken separately (FIG. 9). With traditional protection schemes, the hidden anomalies will sail right through to be used in the retraining process, which results in damage to the model. These anomalies, like the others, may be the artifact of an intentional act by a malicious actor or application. In these cases, an ML model that combines all input parameters together to classify an eye, as a whole, as an outlier is needed.

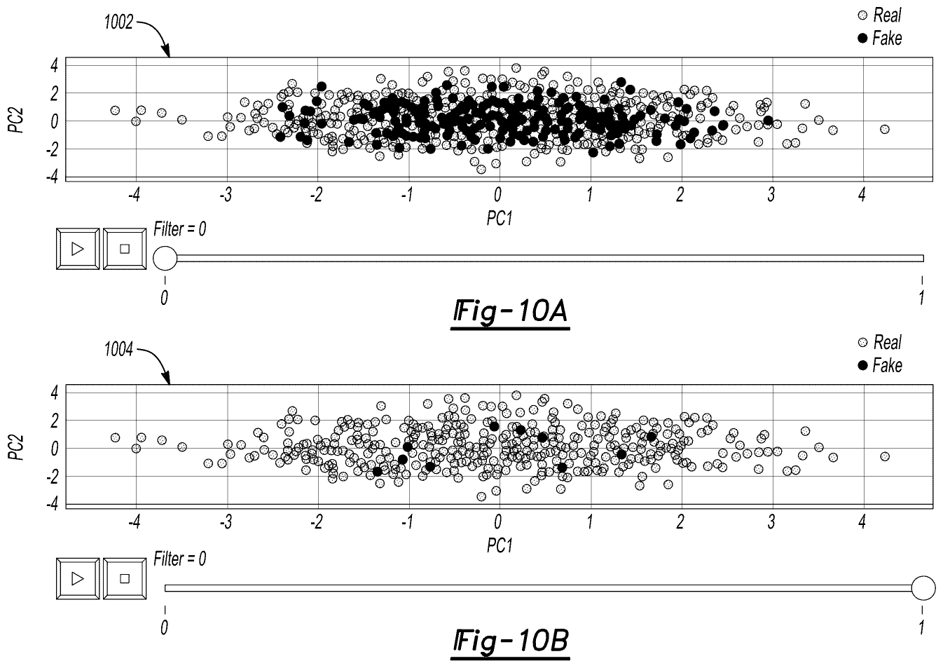

Accordingly, in another aspect of the disclosure, an additional ML model is proposed that is operable to identify these hidden anomalies and filter them from the data. This other ML model is designed to augment, rather than replace, the prior models. FIG. 10A illustrates a graph relevant to an ML model that is trained to remove fake data in the dataset, in accordance with an aspect of the disclosure. As noted, conventional security schemes will simply miss this anomalous data. FIG. 10B illustrates a graph relevant to the ML model of FIG. 10A that illustrates the state of the data after most of the fake or anomalous data were removed upon training and applying the new ML model to the data. The ML model augments the traditional approach in that it captures both apparent and non-apparent outliers (FIGS. 10A-10B). Referring to FIG. 10A, a dataset is shown which has been first reduced to two dimensions from higher-dimensional input data, such as by using principal component analysis (PCA). PCA is a dimension-reduction technique that reduces the number of dimensions in a typically large and unwieldy dataset. PCA is advantageous for ML-based applications because the compacted dataset preserves most or all of the data that was in the high-dimension dataset.

FIG. 10A illustrates a compacted dataset 1002 which has real patient data (identified by the light grey points) and synthetically generated (fake) data (identified by the black data points). If a traditional approach is used, the black data points (fake data) cannot be filtered out as all inputs taken separately would be in-range, as in the example of FIG. 9. FIG. 10B illustrates the results 1004 of the new ML model, the latter being trained to detect and remove data pertaining to synthetic/outlier eyes. The label PC2 is used to denote the correlated datasets. An example of a display for a filter is shown beneath each of FIGS. 10A and 10B. As previously described, the filter is used to remove anomalous data from the dataset 1002 to produce the result 1004. This ML model can be implemented by the processing system in code by initially collecting the data, normalizing it as appropriate, and overlaying it. From there, a test (or ensemble thereof) may be used to detect anomalies in the combined dataset. The ML model accomplishes its objective by running different routines using different measurement perspectives to find the outlier.

The ML model as illustrated in FIGS. 10A-B may be incorporated into the existing ML engine. In some embodiments, the additional ML model is applied together with the three models. In other embodiments, the additional ML model replaces one of the three models. In yet other embodiments, the number of models may be five or greater, with the 2oo3 number adjusted if needed. In still other embodiments, the additional ML model may be manifested as a test, or a series of tests, incorporated within one or more of the three models described in detail above.

The detailed description and the drawings or figures are supportive and descriptive of the present teachings, but the scope of the present teachings is defined solely by the claims. While some of the best modes and other embodiments for carrying out the present teachings have been described in detail, various alternative designs and embodiments exist for practicing the present teachings defined in the appended claims. Moreover, this disclosure expressly includes combinations and sub-combinations of the elements and features presented above and below.

We claim:

1. A system, comprising:
a machine-learning (ML) engine including a data store networked to a hardware instrument, the hardware instrument including at least one sensor used to collect data from a data source, wherein the data in the data store is operable for prospectively retraining a trained data model, the ML engine further including a processing system configured to:
receive the data from the data store;
confirm, using three models, whether anomalies are in the data, each respective one of the three models comprising three tests for detecting three anomaly types, including sequentially applying each respective test of the three tests for detecting prospective anomalies within a configuration of the data relevant to the respective test;
detect, for each respective anomaly type of the three anomaly types, the prospective anomalies using at least two-out-of-three (2oo3) tests in the three models as a threshold for determining whether the data includes anomalous data corresponding to the respective anomaly type;
filter the anomalous data from the data when corresponding tests from at least two out of the three models identify the anomalous data for a relevant anomaly type; and
use the data without the filtered anomalous data in retraining the trained data model.

2. The system of claim 1, wherein the three models include respective tests for point, collective, and contextual anomaly types, respectively, for confirming a presence of the anomalous data.

3. The system of claim 1, wherein the three tests in the three models include unique detection signatures configured to mitigate artificial intelligence (AI) bias when the anomaly types of the models are sequentially applied to the data.

4. The system of claim 1, wherein:
the data comprises an image; and
the three tests in each of the three models comprise an image aesthetic assessment for detecting a first anomaly type, an image impairment assessment for detecting a second anomaly type, and an artifact visibility assessment for detecting a third anomaly type, wherein the three anomaly types include the first anomaly type, the second anomaly type, and the third anomaly type.

5. The system of claim 4, wherein the image comprises an optical coherence tomography (OCT) image.

6. The system of claim 1, wherein one or more of the three tests use an ensemble of techniques or measurements for confirming potential anomalies for the respective anomaly type.

7. The system of claim 1, wherein the ML engine further comprises a data repository for storing the data without the anomalous data prior to the data being used for retraining the trained data model.

8. The system of claim 1, wherein the ML engine is implemented in a secure cloud.

9. The system of claim 1, wherein the ML engine is operable to use one or more of the following quantities for detecting anomalies: White-To-White (WTW); K-Readings; Anterior Chamber Depth (ACD); Axial Length (AL); Not-A-Number (NAN); overflow or underflow values; Pre-op sphere, cylinder or spherical equivalent; or IOL power.

10. The system of claim 1, wherein the processing system is further configured to use an augmented model, the augmented model being configured to combine two or more datasets within the data for detecting anomalies hidden in the combined datasets.

11. A method of a processing system within a machine-learning (ML) engine, comprising:
receiving, from a data store networked to a plurality of hardware instruments, data for prospective use in retraining a trained ML model;
confirming whether potential anomalies in the data are present, comprising using three models each comprising three tests for detecting three respective anomaly types in the data, and sequentially applying each test for detecting prospective anomalies that appear within a configuration of the data relevant to that test;
detecting, for each anomaly type, the prospective anomalies using at least two of the three tests in the three models as a threshold for determining whether the data includes anomalous data corresponding to the anomaly type;
filtering the anomalous data from the data when corresponding tests from at least two out of the three models identify the anomalous data for the anomaly type; and
using the data without the filtered anomalous data in retraining the trained ML model.

12. The method of claim 11, wherein the three tests include respective tests for point, collective, and contextual anomaly types for identifying the anomalous data.

13. The method of claim 11, further comprising:
receiving an image within the data; and
performing, for each anomaly type, at least two of the three tests in each of the three models, the performing comprising conducting an image aesthetic assessment for detecting the point anomaly type, an image impairment assessment for detecting the collective anomaly type, and an artifact visibility assessment for detecting the contextual anomaly type.

14. The method of claim 13, wherein the image comprises an optical coherence tomography (OCT) image.

15. The method of claim 11, further comprising using an ensemble of techniques or measurements in one or more of the three tests for detecting anomalies for the respective anomaly type.

16. The method of claim 11, further comprises storing the data in a data repository prior to the filtered anomalous data being used for retraining the trained ML model.

17. The method of claim 11, further comprising implementing the ML engine in a secure cloud.

18. The method of claim 11, wherein the ML engine is operable to use one or more of the following quantities for detecting anomalies: White-To-White (WTW); K-Readings; Anterior Chamber Depth (ACD); Axial Length (AL); Not-A-Number (NAN); overflow or underflow values; Pre-op sphere; cylinder or spherical equivalent; or IOL power.

19. A system, comprising:
a machine learning (ML) engine comprising a data store coupled to a processing system, the processing system configured to execute code to:
receive a dataset from the data store, the dataset comprising an image;
produce three models, each of the models comprising three tests, each of the tests seeking to detect anomalous data as one of three anomaly types corresponding to each of the three models, wherein each of the three models include respective tests for point, collective, and contextual anomaly types for identifying the anomalous data in the dataset;
perform at least two of the three tests relating to each of the three anomaly types, the three tests in the three models including unique detection signatures configured to mitigate artificial intelligence (AI) bias when the anomaly types of the models are sequentially applied to the received dataset;
separately for each of the anomaly types, detect an anomaly when two-out-of-three (2oo3) tests conclude that the anomaly is present in the dataset;
filter the anomaly from the dataset; and
use data from the dataset to retrain an existing trained ML model.

20. The system of claim 19, wherein the image comprises an optical coherence tomography (OCT) image and the ML engine is implemented in a secure cloud.
